(19) United States
(12) Patent Application Publication
(10) Pub. No.: US 2011/0272333 A1
(43) Pub. Date: Nov. 10, 2011

(54) POPCORN BOWL WITH LID FOR SEPARATING UNPOPPED KERNALS

(76) Inventor: Antonio Garios Vedih, Juiz de Fora - Minas Gerais (BR)

(21) Appl. No.: 13/142,848

(22) PCT Filed: Dec. 23, 2009
(86) PCT No.: PCT/BR2009/000439

§ 371 Date: Jun. 29, 2011

(30) Foreign Application Priority Data
Dec. 30, 2008 (BR) MU8802943-3

(51) Int. Cl. A47J 43/22; B07B 1/02; A47G 19/30

(52) U.S. Cl. 209/680

(57) ABSTRACT

A popcorn bowl with a lid that separates unpopped kernels has versatile uses both as a popcorn container and an unpopped kernel separator, and consists of a bowl (3) for receiving popcorn, generally together with unpopped kernels (5), and a lid (2) with (round, rectangular, etc.) holes sized in such a way that they enable the separation of unpopped kernels from the popcorn by shaking the bowl after appropriate movements

The actual patent of utility model consists of a bowl of popcorn, to be used in residences, stores and the like, of which was invented to improve its usage and efficiency in relation to existing ones. Due its special constructive and usage characteristics, besides being a recipient of popcorn is also an unpopped kernel separator.

After the popcorns being popped in traditional sauces, ordinary and electrical pots and even in the microwave ovens, they are placed in these commonly named “popcorns bowls” (bowls, pots. sauces, etc). These bowls are simply used as recipients to get and store the popcorn and generally the inconvenient seeds that are not popped, named kernels, due their resistance and hardness, may cause damages to human health as the break of teeth, fillings, roots, etc.

In order to solve these problems, the bowl of unpopped lid separator was developed, through which the popcorn is separated from the grains that are not popped (kernels), this way avoiding some problems as: the risk of breaking the teeth, onlays, roots and etc. Other advantage is in the possibility of removing the excess of salt and seasoning of the popcorn, using the same method.

The model of bowl of unpopped kernel lid separator can be properly understood through the following detailed description, according to the attached pictures, where:

Picture 1: perspective view of the bowl and the lids separately;

Picture 2: perspective view of the closed bowl with the separator lid;

Picture 3: perspective view of the bowl of unpopped kernel lid separator, acting on the removing of the unpopped kernels.

According to the related pictures shown above, the model of bowl of popcorn with unpopped kernel lid separator, objective of the actual patent, consists essentially of a bowl (3) where the popped popcorn (4) is placed and that generally comes with unpopped kernels (5), grains of maze that are not popped (5), the lid (1) used to close the bowl (3), of a lid (2) that has dimensioned holes (round, rectangular, etc) to separate the kernels (5) from the bowl (3). After putting the popped popcorn (4) with the kernels (5), it is only necessary to close the bowl (3) with the lid (2), turn the set with the holes downwards and shake it to remove the kernels (5) as shown in picture 3, avoiding the risk of chewing the kernel (5).

1. “Bowl of popcorn with kernel lid separator” Characterized by being consisted with a bowl (3), where the popped popcorn (4) is placed and generally comes with the kernels (5), a lid (2) with holes (round, rectangular, etc) properly dimensioned to separate the kernels (5) after proper movements of shaking and a lid (1) to close the bowl (3).
